(19) United States
(12) Patent Application Publication
(10) Pub. No.: US 2022/0196394 A1
(43) Pub. Date: Jun. 23, 2022

(54) IMAGING DEVICE, CONTROL METHOD THEREFOR, MEASURING DEVICE, AND STORAGE MEDIUM

(71) Applicant: CANON KABUSHIKI KAISHA, Tokyo (JP)

(72) Inventor: Masaaki Matsuoka, Kanagawa (JP)

(21) Appl. No.: 17/556,388

(22) Filed: Dec. 20, 2021

(30) Foreign Application Priority Data
Dec. 22, 2020 (JP) 2020-212180

(51) Int. Cl. G01B 11/25; H04N 5/232

(52) U.S. Cl. CPC G01B 11/25; H04N 5/23212; H04N 5/23296

(57) ABSTRACT

A device projects pattern light to a measuring object, images the measuring object, determines a viewing angle at which the measuring object detected from a subject image is imaged, and changes a light pattern projected by a light projecting unit based on the viewing angle.

### BACKGROUND OF THE INVENTION

### Field of the Invention

The present invention relates to a measurement technique.

### Description of the Related Art

A three-dimensional (also referred to as 3D) scanner is known as a measuring device that measures a dimension, a surface area, or the like of an object. For example, a user can ascertain a weight, a fat percentage, a muscle mass, or the like which is measured through 3D scanning with a human body as a measuring object using a portable device and use the ascertained information for body shape management. Japanese Unexamined Patent Application Publication No. 2013-196355 discloses a technique of acquiring distance images captured at a plurality of angles and measuring a circumference of a specific portion of a human body.

However, in the related art disclosed in Japanese Unexamined Patent Application Publication No. 2013-196355, a measurer needs to appropriately adjust a distance between a measuring device and a measuring object and perform measurement. Since a predetermined level of accuracy or more is required for arrangement of the measuring device or the measuring object, it is not suitable for a user to casually perform automatic measurement using the measuring device.

### SUMMARY OF THE INVENTION

The present invention provides an imaging device that can perform measurement with high precision.

An imaging device according to an embodiment of the present invention includes: a light projecting unit configured to project pattern light to a measuring object; an imaging unit configured to image the measuring object; an acquisition unit configured to acquire distance distribution information from a subject image acquired from the imaging unit; a detection unit configured to detect the measuring object from the subject image; and a control unit configured to perform control such that a viewing angle at which the measuring object detected by the detection unit is imaged is determined and a light pattern projected by the light projecting unit is changed based on the viewing angle.

Further features of the present invention will become apparent from the following description of exemplary embodiments (with reference to the attached drawings).

### BRIEF DESCRIPTION OF THE DRAWINGS

FIG. 1 is a diagram schematically illustrating a configuration of a body scanner according to an embodiment.

FIG. 2 is a block diagram illustrating a configuration of a 3D scanner according to the embodiment.

FIG. 3 is a block diagram illustrating a configuration of a turntable according to the embodiment.

FIG. 4 is a diagram schematically illustrating a configuration of an imaging unit according to the embodiment.

FIG. 5 is a block diagram illustrating a configuration of an image processing unit according to the embodiment.

FIG. 6 is a flowchart illustrating an operation of a 3D scanner according to a first embodiment.

FIG. 7 is a flowchart illustrating an operation of the turntable according to the embodiment.

FIG. 8 is a flowchart illustrating an operation of a 3D scanner according to a second embodiment.

### DESCRIPTION OF THE EMBODIMENTS

Hereinafter, exemplary embodiments of the present invention will be described in detail with reference to the accompanying drawings. In the following embodiments, an example in which the present invention is applied to a body scanner that performs body measurement based on a distance distribution which is periodically acquired while rotating a turntable as an example of an imaging device will be described.

### First Embodiment

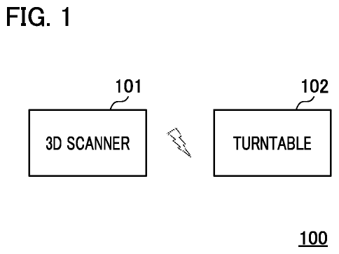

FIG. 1 is a diagram schematically illustrating a configuration of a body scanner 100 according to a first embodiment. The body scanner 100 includes a 3D scanner 101 and a turntable 102. The 3D scanner 101 and the turntable 102 communicate with each other wirelessly.

The 3D scanner 101 acquires 3D shape data of a measuring object. The turntable 102 rotates the measuring object 360° to scan the measuring object. For example, in 3D scanning of a human body for body shape management of a person, measurement is performed while a measuring object is placed directly on the turntable 102. In this embodiment, 3D scanning of a human body is exemplified, but the present invention is not limited thereto and, for example, a moving object such as a pet or a still object such as a work of art may be used as an object of 3D scanning.

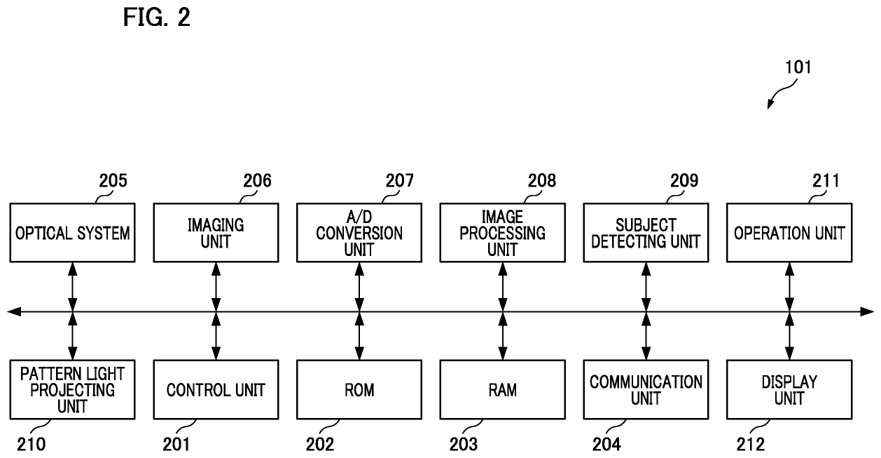

FIG. 2 is a block diagram illustrating a configuration of the 3D scanner 101 illustrated in FIG. 1. A control unit 201 includes, for example, a central processing unit (CPU). The control unit 201 reads operation programs of constituent units of the 3D scanner 101 from a read only memory (ROM) 202, loads the read operation programs into a random access memory (RAM) 203, and executes the operation programs. Accordingly, the operations of the constituent units of the 3D scanner 101 are controlled. The ROM 202 is a rewritable nonvolatile memory and stores parameters and the like required for the operations of the constituent units in addition to the operation programs of the constituent units of the 3D scanner 101. The RAM 203 is a rewritable volatile memory and is used as a temporary storage area of data which is output in the operations of the constituent units of the 3D scanner 101.

A communication unit 204 transmits a command for controlling the turntable 102 illustrated in FIG. 1, or the like using a wireless local area network (LAN) or the like. Wireless technology is used for the communication unit 204 in this embodiment, but the present invention is not limited thereto and a configuration in which communication is performed using a wired cable may be employed.

An optical system 205 is an imaging optical system that forms a subject image on an imaging unit 206. The imaging unit 206 includes an imaging element such as a charge-coupled device (CCD) sensor or a complementary metal oxide semiconductor (CMOS) sensor. The imaging element performs photoelectrical conversion on an optical image in an infrared region which is formed by the optical system 205 and outputs an acquired analog image signal to an A/D conversion unit 207. The A/D conversion unit 207 performs an A/D conversion process on the input analog image signal and outputs digital image data to the RAM 203 to store the digital image data in the RAM 203. The digital image data stored in the RAM 203 is input to an image processing unit 208. The image processing unit 208 performs a process of calculating 3D shape data of a measuring object, or the like.

A subject detecting unit 209 detects a position and a size of a face or an entire body of a subject person which is a measuring object and transmits detection information to the control unit 201. The control unit 201 performs control such that a focal distance of the optical system 205 is adjusted such that a measuring object part has an appropriate imaging magnification. An example of the subject detecting method is disclosed in Japanese Unexamined Patent Application Publication No. 2005-286940, and information of a position or a size of a face or face-likeness (likelihood) can be acquired.

A pattern light projecting unit 210 projects light of an infrared pattern to a measuring object. Accordingly, shape data of even a measuring object with no pattern can be calculated. Regarding the pattern light projecting method, a technique of projecting light of a random dot pattern is disclosed in, for example, US Patent Application Publication No. 2010/0118123. The imaging unit 206 and the pattern light projecting unit 210 are described as constituents corresponding to an infrared region in this embodiment, but the present invention is not limited thereto and they may be constituents corresponding to a visible region or an ultraviolet region.

An operation unit 211 and a display unit 212 are constituted by, for example, a touch panel and a liquid crystal display (LCD) and are used to operate the body scanner 100 or to ascertain a result of body shape measurement. The present invention is not limited to such an example, but the operation unit 211 may be a device that recognizes a gesture or voice and the display unit 212 may be constituted by a smart mirror or a projector. By displaying an interim status of 3D scanning on the display unit 212, a user can find scanning omission early and reduce labor for re-arrangement. When a measuring object is a human body, a period in which the display unit 212 departs from a field of view of a measuring object person occurs depending on a rotation angle of the turntable 102. This period is a period in which the magnitude of the rotation angle of the turntable 102 with respect to an imaging reference direction of the 3D scanner 101 is equal to or greater than about 45° and corresponds to a period in which a user (measuring object person) located on the turntable 102 cannot see a display screen. In this period, the control unit 201 performs control such that power consumption is decreased by stopping a display operation of the display unit 212 or powering off the display unit 212.

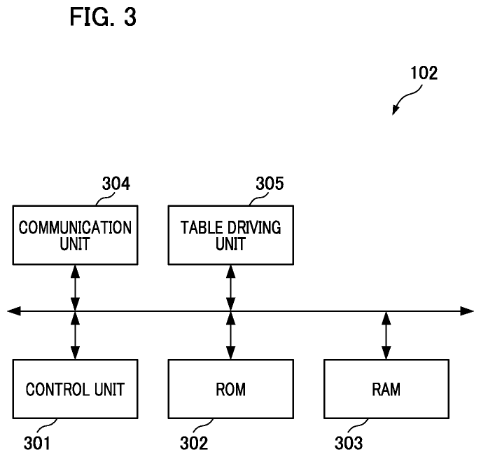

FIG. 3 is a block diagram illustrating a configuration of the turntable 102. A control unit 301 includes, for example, a CPU and controls an operation of the turntable 102. The control unit 301 controls operations of the constituent units of the turntable 102 by reading operation programs of constituent units of the turntable 102 from a ROM 302, loading the read operation programs into a RAM 303, and executing the operation programs. The ROM 302 is a rewritable nonvolatile memory and stores the operation programs of the constituent units of the turntable 102 and parameters and the like required for the operations of the constituent units. The RAM 303 is a rewritable volatile memory and is used as a temporary storage area of data which is output in the operations of the constituent units of the turntable 102.

A communication unit 304 receives a command associated with control of the turntable 102 using a wireless LAN or the like. A table driving unit 305 includes a motor and a mechanism unit and rotates the turntable 102 in accordance with a control command from the control unit 301. An example of the configuration in which a measuring object is rotated by the turntable 102 is described in this embodiment, but, for example, an embodiment in which the turntable 102 has a function of a weighing scale may be realized. In this case, it is possible to more accurately measure a weight.

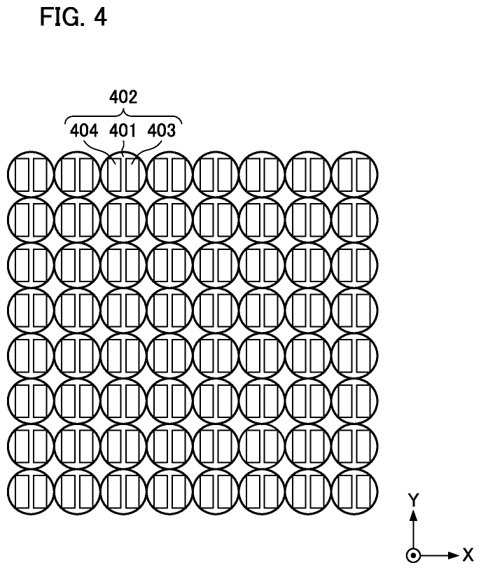

FIG. 4 is a diagram schematically illustrating a configuration of the imaging unit 206 (see FIG. 2). A direction perpendicular to the drawing surface of FIG. 4 is defined as a Z direction (an optical axis direction), an X direction perpendicular to the Z direction on the drawing surface is defined as a horizontal direction, and a Y direction perpendicular to the X direction is defined as a vertical direction. Each pixel 402 includes a microlens 401 and a pair of photoelectric conversion portions 403 and 404 which are divided into two in the X direction. The imaging unit 206 illustrated in FIG. 2 has a configuration of a two-dimensional array in which a plurality of pixels 402 are regularly arranged on an X-Y plane.

In FIG. 4, a pair of photoelectric conversion portions 403 and 404 corresponding to each microlens output signals of an A image and a B image which are a pair of images. With this configuration, the signals of the A image and the B image as a pair can be acquired from a pair of optical images based on a pair of light beams passing through different areas with different pupils of the optical system 205 illustrated in FIG. 2. The acquired signals of the A image and the B image are used for calculation of a distance image which will be described later in addition to automatic focus control. Data of the distance image is two-dimensional data which includes distance distribution information in a depth direction of an image and in which pixel values indicate distance values or depth information corresponding to the distance values.

In addition to the configuration in which an A image signal and a B image signal are read from a pair of photoelectric conversion portions corresponding to each microlens, a configuration in which an A image signal and an A+B image signal are read may be employed. The A+B image is an added image in which the signals of the A image and the B image are added and can be acquired from a pair of photoelectric conversion portions. The B image signal can be acquired by subtracting the A image signal from the A+B image signal. It is possible to detect a subject with lower noise by using the A+B image. By employing a pupil split type imaging element including a plurality of photoelectric conversion portions which are divided into three or more parts, it is possible to acquire a multi-viewpoint image.

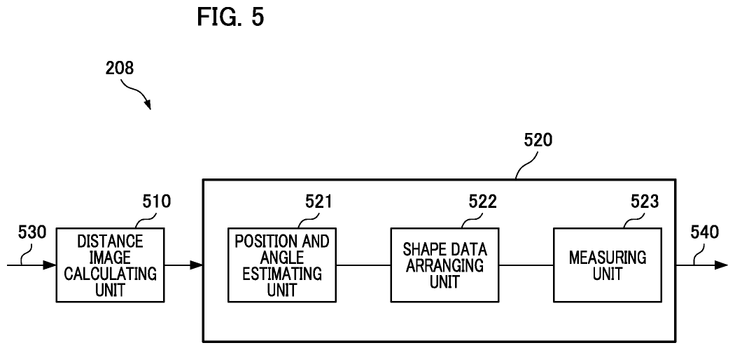

FIG. 5 is a block diagram illustrating the configuration of the image processing unit 208 illustrated in FIG. 2. A distance image calculating unit 510 acquires an input signal 530 of an A image and a B image from the imaging unit 206 and calculates a distance image. A known method can be used to calculate the distance image from the A image and the B image. A defocus value distribution of a measuring object can be calculated, for example, using a method disclosed in Japanese Unexamined Patent Application Publication No. 2008-15754. By converting a defocus value at an image point to a distance to an object point using a “Gaussian lens imaging expression” expressed as Expression (1), it is possible to calculate data of the distance image.

1/a+1/b=1/f (1)

In Expression (1), f denotes a focal distance of the imaging optical system, a denotes a distance from a front principal plane of the lens to an object point, and b denotes a distance from a rear principal plane of the lens to an image point. Expression (1) is an expression based on the assumption that the defocus value is zero and the distance a to an object point corresponding to the defocus value (referred to as def) can be calculated by Expression (2).

1/a+1/(b+def)=1/f (2)

This embodiment employs a configuration in which an imaging unit capable of acquiring a pair of viewpoint images (a parallax image) with even a monocular optical system illustrated in FIG. 4 is used and a pupil split type imaging element including a plurality of photoelectric conversion portions corresponding to each of a plurality of microlenses is used. The present invention is not limited thereto and can also be applied to a configuration in which a plurality of viewpoint images are acquired with a multi-eye optical system. The parallax image includes a plurality of viewpoint images from different viewpoints.

The turntable 102 is rotated and a process of imaging a measuring object is performed while changing an angle. Accordingly, the distance image calculating unit 510 acquires a plurality of distance images by imaging the measuring object at a plurality of angles. For example, the distance image calculating unit 510 can acquire a distance image as a moving image by continuous imaging and acquire distance images of a plurality of successive frames.

A measuring control unit 520 includes a position and angle estimating unit 521, a shape data arranging unit 522, and a measuring unit 523. The functions of the constituent units are realized by causing a CPU to execute a predetermined program. The measuring control unit 520 outputs data of a measurement result 540. A known method can be used as a method of causing the measuring control unit 520 to calculate the measurement result 540 from the distance images. For example, a method disclosed in Japanese Unexamined Patent Application Publication No. 2013-196355 can be used.

The measuring control unit 520 includes a CPU, a buffer memory, a program memory, and a nonvolatile memory. The CPU performs various arithmetic processes. The buffer memory temporarily stores results of arithmetic operations performed by the CPU. The program memory and the nonvolatile memory store various programs executed by the CPU, control data, and the like. The measuring control unit 520 can perform various processes by causing the CPU to execute a program stored in the program memory.

The position and angle estimating unit 521 generates shape data by performing coordinate conversion of a distance image. Shape data is point group data indicating a three-dimensional shape of an object using a group of points with coordinate values in a three-dimensional space corresponding to the surface of the object. The position and angle estimating unit 521 estimates a position and an angle relative to shape data generated from a distance image of a previous frame. The position and angle estimating unit 521 integrates the positions and the angles of all frames relative to other frames. Accordingly, the position and angle estimating unit 521 can calculate a position and an angle with respect to a head frame.

The shape data arranging unit 522 acquires the shape data generated by the position and angle estimating unit 521 and arranges the shape data at the positions and angles estimated by the position and angle estimating unit 521. The shape data arranging unit 522 arranges the shape data such that a surface shape thereof overlaps the shape data generated from the distance image of the previous frame. When an input luminance image is a first frame, the shape data arranging unit 522 arranges the shape data at an arbitrary position and an arbitrary angle.

The shape data arranging unit 522 arranges the shape data of all the frames which are used at the positions and the angles calculated through the process of estimating a position and an angle. Accordingly, partial surface shapes captured from one direction are added and combined. As a result, the shape data arranging unit 522 can acquire a shape of almost the entire circumference of the object.

The measuring unit 523 detects and measures a measuring target on the object based on the output of the shape data arranging unit 522. For example, the measuring unit 523 detects at least one of a predetermined segment, a curve, a circumscribed rectangular parallelepiped, a two-dimensional area on the surface, and a three-dimensional area of the object as a measuring target. The measuring unit 523 measures a length, an area, or a volume as the measurement target.

An example in which measurement of a human body is performed will be described below. The measuring unit 523 detects a chest, an abdomen, and a hip of a human body and calculates a chest circumference, an abdominal circumference, and a pelvic circumference. For example, the measuring unit 523 performs a process of dividing shape data which is arranged with matched positions and angles at minute height intervals in the horizontal direction, projecting the shape data onto the horizontal plane, and approximating a group of projected points to a closed curve. The measuring unit 523 determines whether a part corresponding to the horizontal plane is a head, a trunk, an arm, or a leg based on the height of the horizontal plane and the number of closed curves in the horizontal plane. When the part is identified as a trunk, the measuring unit 523 detects a part in which the length of the closed curve is minimized out of parts of the trunk as an abdominal circumference. The measuring unit 523 detects a part which is located above the abdominal circumference in the trunk and in which the length of the closed curve is maximized as a chest circumference. The measuring unit 523 detects a part which is located below the abdominal circumference in the trunk and in which the length of the closed curve is maximized as a hip.

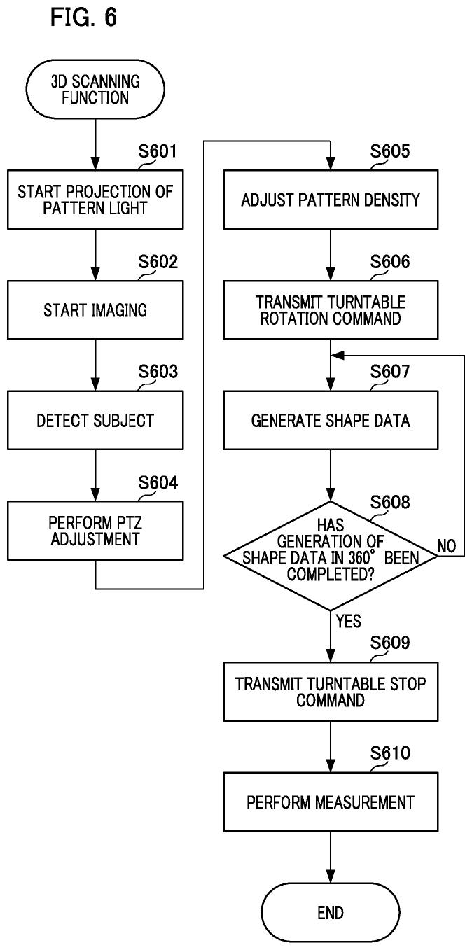

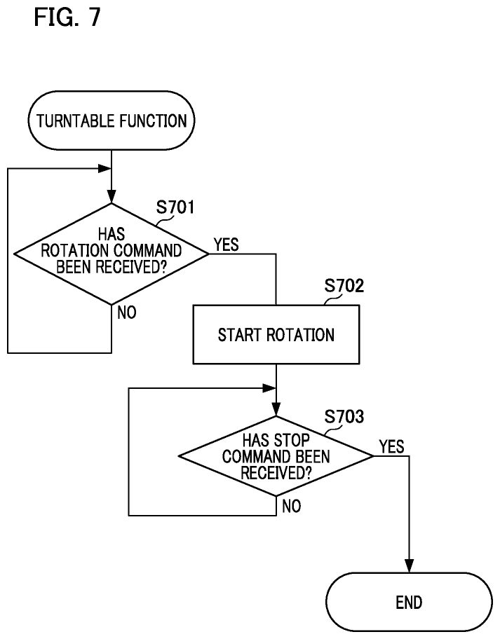

The operation of the body scanner 100 will be described below with reference to FIGS. 6 and 7. FIG. 6 is a flowchart illustrating the operation of the 3D scanner 101. FIG. 7 is a flowchart illustrating the operation of the turntable 102.

The 3D scanner 101 performs pattern light projection using the pattern light projecting unit 210 in S601 of FIG. 6 and starts imaging using the imaging unit 206 in S602. Then, in S603, the subject detecting unit 209 detects the size of an entire body and the position of a human body which is a measuring object based on a subject image. When detection of a subject is performed, a zoom magnification of the optical system 205 illustrated in FIG. 2 is set to a magnification corresponding to a wide end. Accordingly, it is possible to avoid a situation in which the entire body cannot be detected because only a part of the human body appears.

In S604, the 3D scanner 101 performs panning/tilting/zooming adjustment (hereinafter referred to as PTZ adjustment) of the optical system 205. A panning value, a tilting value, and a zoom magnification suitable for fully imaging an entire human body in a screen without cutting off the human body are calculated and PTZ adjustment is performed. When control of panning, tilting, or zooming is performed, the control unit 201 performs control such that an A+B image signal in which an A image signal from a first photoelectric conversion portion of the imaging element and a B image signal from a second photoelectric conversion portion are added is read. The control unit 201 performs control such that the A image signal and the B image signal are read from the corresponding photoelectric conversion portions in automatic focus control.

When a detection likelihood in the subject detecting unit 209 is less than a threshold value in S603, guidance for urging the user to change a measuring place in order to avoid an influence of external light or the like is displayed. Alternatively, a process of applying a panning value, a tilting value, and a zoom magnification which are default values without performing PTZ adjustment is performed. In this embodiment, it is possible to maximize a detection resolution of an image difference without cutting off a measuring object in calculating a distance image.

In S605 subsequent to S604, a pattern density is adjusted. A density of pattern light projected by the pattern light projecting unit 210 changes depending on the zoom magnification of the optical system 205 illustrated in FIG. 2. The pattern density is changed, for example, by changing a projection magnification of a projection optical system of the pattern light projecting unit 210. Control is performed such that the pattern density is set to be lower (coarser) when the zoom magnification of the optical system 205 changes to a magnification on a wider angle side and the pattern density is set to be higher (denser) when the zoom magnification changes to a magnification on a more distant side. That is, the control unit 201 of the 3D scanner 101 determines an imaging viewing angle of the measuring object and performs control such that a spatial frequency of a projection pattern is changed based on the determined imaging viewing angle. Accordingly, even when the zoom magnification of the optical system 205 changes, it is possible to decrease a change in detected spatial frequency of an image difference detecting operation in calculating a distance image and to decrease a variation in a distance calculation result.

The projection pattern has a random dot pattern in this embodiment, but the present invention is not limited thereto. For example, a projection pattern such as a stripe pattern including a component in a direction perpendicular to a parallax direction may be used. In the case of a stripe pattern, control is performed such that the interval of the stripe pattern is increased when the zoom magnification of the optical system 205 changes to a magnification on a wider angle side and the interval of the stripe pattern is decreased when the zoom magnification changes to a magnification on a more distant side. Alternatively, zoom control of the projection optical system of the pattern light projecting unit 210 may be performed in cooperation with imaging without changing a projection pattern.

The 3D scanner 101 wirelessly transmits a rotation (start) command to the turntable 102 in order to rotate the measuring object in S606, and generates shape data while rotating the measuring object in S607. In S608, the 3D scanner 101 determines whether generation of shape data in an angle range of 360° has been completed. When it is determined that generation of shape data over 360° has been completed, the routine proceeds to the process of S609. When it is determined that generation of shape data over 360° has not been completed, the routine returns to S607 and the process is consecutively performed.

In S609, the 3D scanner 101 wirelessly transmits a stop command to the turntable 102. Then, in S610, the 3D scanner 101 measures a chest circumference, an abdominal circumference, and a pelvic circumference of a human body. Since the measurement result is displayed on the display unit 212 according to a user's operation using the operation unit 211 illustrated in FIG. 2, the user can ascertain the measurement result. After S610, the 3D scanning process ends.

On the other hand, the turntable 102 determines whether a rotation start command has been received in S701 illustrated in FIG. 7. When it is determined that a rotation start command has been received by the turntable 102, the routine proceeds to the process of S702 and rotation of the turntable 102 is started. When it is determined that a rotation start command has not been received by the turntable 102, the determination process of S701 is repeatedly performed.

In S703 subsequent to S702, the turntable 102 determines whether a rotation stop command has been received. When it is determined that a rotation stop command has been received by the turntable 102, the routine ends after rotation of the turntable 102 is stopped. When it is determined that a rotation stop command has not been received by the turntable 102, the turntable 102 continues to rotate and the determination process of S703 is repeatedly performed.

In this embodiment, an example in which the measurement result is calculated by the 3D scanner 101 and management and display are performed has been described above. In another embodiment, a configuration in which the 3D scanner 101 transmits data to an external device (an information processing device) such as a smartphone may be employed. The external device having received data performs measurement calculation and management and display of a result.

The present invention is not limited to an embodiment in which a common image is used as an image for detecting a subject and an image for calculating a distance image, and an embodiment in which a plurality of imaging units are used may be realized. That is, an image for detecting a subject is acquired by a first imaging unit and an image for calculating a distance image is acquired by a second imaging unit. With this configuration, calculation of a distance image can be performed in an infrared region and detection of a subject can be performed in a visible region. Since a subject image in the visual region can be acquired, it is possible to detect a subject without being affected by projection of pattern light in the infrared region.

In this embodiment, an entire human body is measured, but the present invention is not limited thereto and only a specific part may be measured. For example, when only an abdominal circumference is measured, an abdominal part of the entire body is detected and PTZ adjustment is performed such that an appropriate imaging magnification is achieved without cutting off the abdominal part. It is possible to maximize a detection resolution of an image difference in only a desired part and to measure a change in a small measurement result.

It is assumed above that only a person who is a measuring object is detected as a subject, but, for example, a family member living together may be detected as a subject and a person or an object other than a main subject may enter an imaging viewing angle. The present invention can also be applied to a case in which an unintended object is detected as a subject. For example, a process of selecting a subject located closest to the 3D scanner 101 as a measuring object is performed using distance information or image size information of the subject. In the process of identifying a nearest subject, a process of determining a depth from the distance image is performed or a process of selecting a subject with a largest image size is performed based on the image size information of the subject. Alternatively, a process of preferentially selecting a person registered by personal authentication may be performed. When a plurality of persons are registered, for example, a process of preferentially selecting a person who has been most recently measured by the body scanner 100 is performed or a process of preferentially selecting a person with a high measurement frequency is performed. By managing a measurement result for each registered person, it is possible to enhance a user's convenience. The process of selecting a specific subject out of a plurality of subjects as a measuring object is performed by the control unit 201 and the subject detecting unit 209.

In this embodiment, since the signals of the A image and the B image output from the imaging unit 206 illustrated in FIG. 2 are also used for automatic focus control, signals of two viewpoint images are read even when a distance image is not calculated. The present invention is not limited thereto and control may be performed such that the A+B image, that is, a signal of an image from only one viewpoint, is read when a distance image is not calculated. For example, in a configuration in which a parallax image is acquired using a multi-eye optical system, an imaging unit corresponding to one viewpoint is used when distance distribution information is not acquired. Since an imaging unit corresponding to another viewpoint can be powered off, it is possible to decrease power consumption of a system. On the other hand, when distance distribution information is acquired, imaging units corresponding to a plurality of viewpoints are used.

According to this embodiment, when a size of a subject changes like a difference between an adult and a child or when an imaging distance changes due to a user riding on the turntable without care, it is possible to stably acquire a measurement result of 3D scanning.

### Second Embodiment

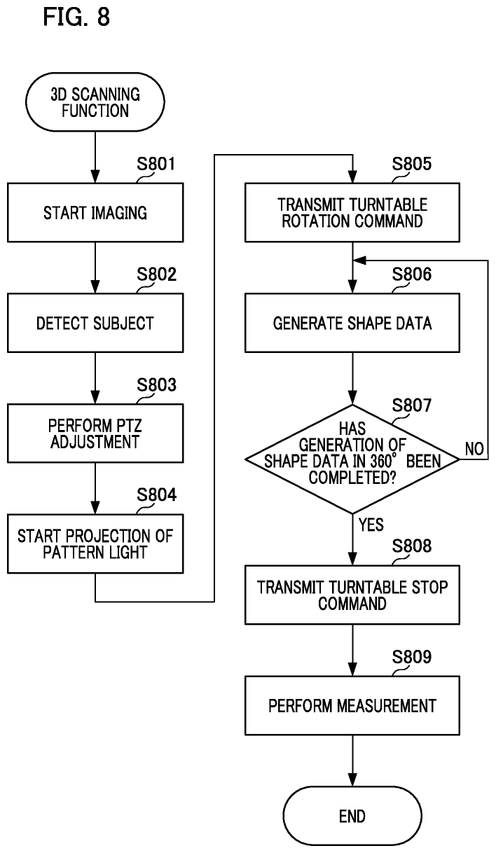

A second embodiment of the present invention will be described below with reference to FIGS. 7 and 8. A hardware configuration of a body scanner according to this embodiment is the same as the configuration in the first embodiment. Accordingly, differences from the first embodiment will be mainly described below, the same constituents as in the first embodiment will be referred to by the same reference signs, and detailed description thereof will be omitted. FIG. 8 is a flowchart illustrating an operation of a 3D scanner 101 according to this embodiment.

In S801 of FIG. 8, the 3D scanner 101 starts imaging using the imaging unit 206 illustrated in FIG. 2. Then, in S802, the subject detecting unit 209 illustrated in FIG. 2 detects a size and a position of an entire human body which is a measuring object.

In S803, the 3D scanner 101 calculates a panning value, a tilting value, and a zoom magnification which are suitable for fully capturing an image of the entire human body in a screen without cutting off the human body and performs PTZ adjustment of the optical system 205 illustrated in FIG. 2. After PTZ adjustment has been completed, the 3D scanner 101 starts projection of pattern light using the pattern light projecting unit 210 illustrated in FIG. 2 in S804. In this embodiment, unlike the first embodiment, projection of pattern light is not performed before the subject detecting unit 209 detects a subject. As a result, since detection of a subject is performed using an image without pattern light projected (a subject image) at the time of detection of the subject, it is possible to decrease erroneous detection at the time of detection of a subject. By not calculating distance distribution information at the time of detection of a subject and calculating the distance distribution information after PTZ adjustment has been completed, it is possible to reduce a process load.

In S805, the 3D scanner 101 transmits rotation (start) command to the turntable 102 in order to rotate the measuring object. The turntable 102 receives the rotation (start) command from the 3D scanner 101 and starts its rotation (FIG. 7: S701, S702). In S806, the 3D scanner 101 generates shape data based on distance distribution information which is periodically acquired for the rotating measuring object.

In S807, the 3D scanner 101 determines whether generation of shape data in an angle range of 360° has been completed. The determination process of S807 is repeatedly performed until it is determined that generation of shape data has been completed, and the 3D scanner 101 transmits a rotation stop command to the turntable 102 in S808 when it is determined that generation of shape data has been completed. The turntable 102 receives the stop command and stops its rotation (FIG. 7: YES in S703).

In S809, the 3D scanner 101 measures a chest circumference, an abdominal circumference, and a pelvic circumference of a human body. A user can operate the operation unit 211 illustrated in FIG. 2 and ascertain a measurement result displayed on the display unit 212.

In this embodiment, the control unit 201 of the 3D scanner 101 stops projection of pattern light when a subject is detected, and sets projection of pattern light to be valid and performs a 3D scanning process when distance distribution information is acquired. Since a likelihood of erroneous detection at the time of detection of a subject can be decreased and accuracy of PTZ adjustment can be increased, it is possible to measure a body shape with higher accuracy.

According to this embodiment, it is possible to provide an imaging device that can automatically perform 3D scanning with high accuracy without cutting of a subject even in a state in which accuracy of arrangement of a measuring device or a measuring object is not strictly managed. While exemplary embodiments of the present invention have been described above, the present invention is not limited to the embodiments and can be modified and altered in various forms without departing from the gist thereof.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-212180, filed Dec. 22, 2020, which is hereby incorporated by reference wherein in its entirety.

What is claimed is:

1. An imaging device comprising:
at least one processor; and
at least one memory holding a program that makes the processor function as:
a light projecting unit configured to project pattern light to a measuring object;
an imaging unit configured to image the measuring object;
an acquisition unit configured to acquire distance distribution information from a subject image acquired from the imaging unit;
a detection unit configured to detect the measuring object from the subject image; and
a control unit configured to perform control such that a viewing angle at which the measuring object detected by the detection unit is imaged is determined and a light pattern projected by the light projecting unit is changed based on the viewing angle.

2. An imaging device comprising:
at least one processor; and
at least one memory holding a program that makes the processor function as:
a light projecting unit configured to project pattern light to a measuring object;
an imaging unit configured to image the measuring object;
an acquisition unit configured to acquire distance distribution information from a subject image acquired from the imaging unit;
a detection unit configured to detect the measuring object from the subject image; and
a control unit configured to stop the projection of pattern light from the light projecting unit when the detection unit detects the measuring object and to set the projection of pattern light from the light projecting unit to be valid when the acquisition unit acquires the distance distribution information.

3. The imaging device according to claim 1, wherein the control unit performs control such that the pattern is made to be coarser or an interval of the pattern is increased when the viewing angle is changed to a wider angle side and the pattern is made to be denser or the interval of the pattern is decreased when the viewing angle is changed to a more distant side.

4. The imaging device according to claim 1, wherein the control unit controls panning, tilting, or zooming of the imaging unit when the detection unit detects the measuring object.

5. The imaging device according to claim 4, wherein the control unit sets a zoom magnification to a magnification corresponding to a wide end, and
wherein the detection unit acquires a subject image captured at the magnification and detects the measuring object.

6. The imaging device according to claim 1, wherein the imaging unit is able to acquire a plurality of images from different viewpoints, and
wherein the imaging unit acquires the plurality of images when the acquisition unit acquires the distance distribution information and the imaging unit acquires an image from one viewpoint when the acquisition unit does not acquire the distance distribution information.

7. The imaging device according to claim 6, wherein the imaging unit acquires an image from one viewpoint when the detection unit detects the measuring object.

8. The imaging device according to claim 1, wherein the detection unit detects a specific part of the measuring object, and
wherein the control unit adjusts the viewing angle of the imaging unit to a viewing angle at which the detected part is imaged.

9. The imaging device according to claim 1, wherein the detection unit and the control unit select a subject located closest to the imaging device, a subject with a largest size of a subject image, or a previously registered subject as the measuring object when a plurality of measuring objects are detected.

10. The imaging device according to claim 1, further comprising a generation unit configured to generate shape data of the measuring object from the distance distribution information.

11. The imaging device according to claim 10, wherein the control unit performs control such that a situation in which the generation unit is generating shape data is displayed on a display unit.

12. The imaging device according to claim 1, wherein the control unit controls a turntable turning the measuring object and performs control such that the acquisition unit periodically acquires the distance distribution information while rotating the measuring object using the turntable.

13. The imaging device according to claim 11, wherein the control unit controls a turntable turning the measuring object and performs control such that display of the display unit is performed when a rotation angle of the turntable is in a first range and display of the display unit is stopped when the rotation angle of the turntable is in a second range.

14. The imaging device according to claim 1, wherein the imaging unit includes an imaging element including a plurality of microlenses and a plurality of photoelectric conversion portions corresponding to the microlenses, and
wherein the control unit performs control such that a signal in which a signal of a first photoelectric conversion portion and a signal of a second photoelectric conversion portion are added is read when the detection unit detects the measuring object.

15. The imaging device according to claim 4, wherein the imaging unit includes an imaging element including a plurality of microlenses and a plurality of photoelectric conversion portions corresponding to the microlenses, and
wherein the control unit performs control such that a signal in which a signal of a first photoelectric conversion portion and a signal of a second photoelectric conversion portion are added is read when panning, tilting, or zooming of the imaging unit is controlled.

16. A measuring device having a turntable that turns a measuring object, the measuring device comprising:
at least one processor; and
at least one memory holding a program that makes the processor function as:
a light projecting unit configured to project pattern light to the measuring object;
an imaging unit configured to image the measuring object;
an acquisition unit configured to acquire distance distribution information from a subject image acquired from the imaging unit;
a detection unit configured to detect the measuring object from the subject image; and
a control unit configured to stop the projection of pattern light from the light projecting unit when the detection unit detects the measuring object and to set the projection of pattern light from the light projecting unit to be valid when the acquisition unit acquires the distance distribution information,
wherein the control unit measures the measuring object that is rotated by the turntable.

17. A control method for an imaging device, the control method comprising:
a step of projecting pattern light to a measuring object using a light projecting unit;
a step of imaging the measuring object using an imaging unit;
a step of acquiring distance distribution information from a subject image acquired from the imaging unit; and
a step of detecting the measuring object from the subject image;
wherein control is performed such that a viewing angle at which the measuring object is imaged is determined and then a light pattern projected by the light projecting unit is changed based on the viewing angle when the measuring object is detected.

18. A control method for an imaging device, the control method comprising:
a step of projecting pattern light to a measuring object using a light projecting unit;
a step of imaging the measuring object using an imaging unit;
a step of acquiring distance distribution information from a subject image acquired from the imaging unit; and
a step of detecting the measuring object from the subject image,
wherein control is performed such that the projection of pattern light from the light projecting unit is stopped when the measuring object is detected and the projection of pattern light from the light projecting unit is set to be valid when the distance distribution information is acquired.

19. A non-transitory computer-readable medium storing a program causing a computer to execute a process, the process comprising:
a step of projecting pattern light to a measuring object using a light projecting unit;
a step of imaging the measuring object using an imaging unit;
a step of acquiring distance distribution information from a subject image acquired from the imaging unit; and
a step of detecting the measuring object from the subject image;
wherein control is performed such that a viewing angle at which the measuring object is imaged is determined and then a light pattern projected by the light projecting unit is changed based on the viewing angle when the measuring object is detected.
